(19) United States
(12) Patent Application Publication
(10) Pub. No.: US 2017/0232446 A1
(43) Pub. Date: Aug. 17, 2017

(54) ORDNANCE REMEDIATION SYSTEM

(71) Applicants: Gale W. Hillis, Bandon, OR (US); Craig J. Morris, Monmouth, IL (US)

(72) Inventors: Gale W. Hillis, Bandon, OR (US); Craig J. Morris, Monmouth, IL (US)

(21) Appl. No.: 15/046,174

(22) Filed: Feb. 17, 2016

(51) Int. Cl. B02C 23/14; B03C 7/08; B03C 7/00; B02C 23/12; B07C 5/34

(52) U.S. Cl. CPC B02C 23/14; B02C 23/12; B07C 5/34; B03C 7/003; B03C 7/08; B07C 2201/006

(57) ABSTRACT

A system for eliminating unexploded ordnance from a mixture. The system includes a separation plant, including a crusher, a magnetic separation station, and a screen plant. The crusher reduces the size of pieces in the mixture, the magnetic separator separates pieces containing a significant amount of ferrous metal, and the screen separates small pieces from larger pieces. The fine output of the screen is composed of pieces that are sufficiently small to pose little hazard; they may be further subjected to heat treatment. Large pieces containing ferrous metal, or large pieces containing nonferrous metal, may be explosive and are transported, using an unmanned machine, to an inspection plant where they are sorted and where any unexploded ordnance is identified and disposed of. The separation plant is sufficiently distant from the inspection plant that an explosion at the separation plant does not pose a hazard to personnel at the inspection plant.

### FIELD

One or more aspects of embodiments according to the present invention relate to former military sites and ranges that may be contaminated with military munition components, and more particularly to a system and method for efficiently rendering material from such sites and ranges safe.

### BACKGROUND

Military activities involving explosives may result in buried unexploded ordnance. For example, a testing range may accumulate ordnance, some of which may explode as part of testing exercises, and some of which may remain unexploded, for example as a result of a defective fuse. Testing ranges may include such ordnance and ordnance fragments, mixed with rocks and other dirt.

To reclaim a testing range for other uses, it may be necessary to clear at least the unexploded ordnance so that it does not pose a hazard, and it may be desirable also to extract metal components, e.g., fragments of exploded ordnance. The clearing of the range may involve separating unexploded ordnance and other metal components from dirt, and exploding the unexploded ordnance to eliminate any danger it may otherwise pose.

The separating of unexploded ordnance from dirt may be costly because of the safety precautions required to protect operators from injury. For example, if metal is separated from dirt in a separation plant, it may be necessary to bring separation plant operations to a halt when a piece of unexploded ordnance is found, so that explosive ordnance disposal experts may render it safe without being exposed to risk from additional pieces of unexploded ordnance that could explode, if the plant were to continue to operate.

Thus, there is a need for a system and method of safe and efficient processing of dirt containing explosive ordinance, to render it safe.

### SUMMARY

Aspects of embodiments of the present disclosure are directed toward a system in which a received dirt mixture is processed to separate from it any potentially hazardous pieces. Potentially hazardous pieces are separated from the dirt mixture using a combination of crushing, separation according to size in a screen plant, magnetic separation, and eddy current separation. The potentially hazardous pieces are transported to a remote inspection plant to identify and dispose of any explosive pieces among them. The remaining material may be heat treated to render it safe.

According to an embodiment of the present invention there is provided a system for eliminating unexploded ordnance from a mixture, the system including: a separation plant, including: a first crusher having an input and an output, the first crusher being configured to receive a stream of pieces of material at the input and to produce, at the output, a stream of pieces of material of reduced size, a first magnetic separation station having an input, a first output, and a second output, and being configured to receive a stream of material at the input and to produce respective output streams of material at the first output and at the second output, by directing ferrous metal pieces to the second output; and a screen plant having an input, a first output and a second output, and being configured to receive a stream of material at the input, and to produce respective output streams of material at the first output and at the second output, by directing pieces larger than a threshold size to the first output and directing pieces smaller than a threshold size to the second output; and an inspection plant having an input for receiving, from the separation plant, pieces larger than the threshold size, the inspection plant including an inspection station for identifying unexploded ordnance among the received pieces, each of the first crusher, the first magnetic separation station, and the screen plant having an input or an output connected to an input or an output of another of the first crusher, the first magnetic separation station, and the screen plant, the inspection plant being sufficiently distant from the separation plant to prevent unexploded ordnance at the separation plant from posing a personnel hazard at the inspection plant.

In one embodiment, each of the first crusher, the first magnetic separation station, and the screen plant has an input or an output connected to an input or an output of another of the first crusher, the first magnetic separation station, and the screen plant by a conveyor.

In one embodiment, the distance between the separation plant and the inspection plant is at least 1,000 feet.

In one embodiment, in a first mode of operation: the first output of the screen plant is connected to the input of the first magnetic separation station; the first output of the first magnetic separation station is connected to the input of the first crusher; the second output of the first magnetic separation station is connected to a storage bin for large metal pieces; and the output of the first crusher is connected to the input of the screen plant.

In one embodiment, in a second mode of operation: the first output of the screen plant is connected to the input of the first magnetic separation station; the first output of the first magnetic separation station is connected to the storage bin for large metal pieces; and the output of the first crusher is connected to the input of the screen plant.

In one embodiment, the system includes a second magnetic separation station having an input, a first output, and a second output, and being configured to receive a stream of material at the input and to produce respective output streams of material at the first output and at the second output, by directing ferrous metal pieces to the second output, wherein the first output of the second magnetic separation station is connected to the screen plant and the second output of the second magnetic separation station is connected to a storage bin for large metal pieces.

In one embodiment, the system includes a second crusher having an input and an output, the second crusher being configured to receive a stream of pieces of material at the input and to produce, at the output, a stream of pieces of material of reduced size, wherein the output of the second crusher is connected to the input of the second magnetic separation station.

In one embodiment, the second crusher is a jaw crusher.

In one embodiment, the system includes an unmanned piece of earth-moving equipment for feeding the second crusher.

In one embodiment, the system includes a third magnetic separation station having an input, a first output, a second output, and a third output, and being configured to receive a stream of material at the input and to produce respective output streams of material at the first output, at the second output, and at the third output, by directing ferrous metal pieces to the second output or to the third output, wherein the second output of the screen plant is connected to the input of the third magnetic separation station.

In one embodiment, the third magnetic separation station includes a magnetic separator configured to direct ferrous metal pieces to the third output of the third magnetic separation station.

In one embodiment, the third magnetic separation station further includes a conveyor with a magnetic head pulley configured to direct ferrous metal pieces to the second output of the third magnetic separation station.

In one embodiment, the system includes: a stacker conveyor having an input and an output; and a first stockpile at the output of the stacker conveyor, wherein the input of the stacker conveyor is connected to the second output of the screen plant.

In one embodiment, the system includes an eddy current separator having an input, a first output, and a second output, and being configured to process an input stream of material and to produce a first output stream of material and a second output stream of material, by directing electrically conductive pieces into the second output stream, wherein the input of the eddy current separator is connected to the second output of the screen plant.

In one embodiment, the first crusher is an impactor.

In one embodiment, each connection between: the first crusher, the first magnetic separation station, and the screen plant includes a conveyor.

In one embodiment, the system includes an unmanned bin-hauling machine for moving a bin containing pieces of material larger than the threshold size to the inspection plant.

In one embodiment, the inspection plant includes a conveyor configured to display metal pieces for inspection, the conveyor feeding a chute with a trap door, the chute being configured to deposit metal pieces in a storage bin when the trap door is open, and to deposit metal pieces into a sand pan when the trap door is closed.

According to an embodiment of the present invention there is provided a method for eliminating unexploded ordnance from a stream of material, the method including: at a first location: crushing pieces in an input stream to form an output stream; separating pieces in an input stream into two output streams, according to magnetic characteristics of the pieces; and separating pieces in an input stream into two output streams, according to the size of the pieces relative to a threshold size; transporting pieces larger than the threshold size to a second location sufficiently remote from the first location that an explosion at the first location does not pose a personnel hazard at the second location; and identifying, at the second location, potentially explosive pieces, wherein each of the processes of crushing, separating according to magnetic characteristics, and separating according to size includes receiving material from or providing material to another of the processes of crushing, separating according to magnetic characteristics, and separating according to size.

### BRIEF DESCRIPTION OF THE DRAWINGS

These and other features and advantages of the present invention will be appreciated and understood with reference to the specification, claims, and appended drawings wherein:

FIG. 1 is a block diagram of an ordnance remediation system, according to an embodiment of the present invention;

FIG. 2 is a schematic diagram of a first part of a separation plant, according to an embodiment of the present invention;

FIG. 3 is an illustration of a portion of a separation plant, according to an embodiment of the present invention;

FIG. 4 is an illustration of another portion of a separation plant, according to an embodiment of the present invention;

FIG. 5 is an illustration of another portion of a separation plant, according to an embodiment of the present invention;

FIG. 6 is a schematic diagram of a second part of a separation plant, according to an embodiment of the present invention;

FIG. 7 is a schematic diagram of an inspection plant, according to an embodiment of the present invention; and

FIG. 8 is an illustration of a portion of an inspection plant, according to an embodiment of the present invention.

### DETAILED DESCRIPTION

The detailed description set forth below in connection with the appended drawings is intended as a description of exemplary embodiments of an ordnance remediation system provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

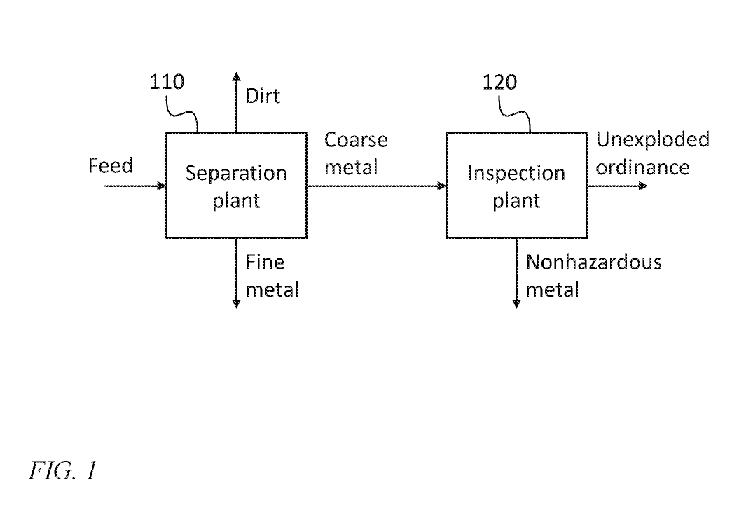

Referring to FIG. 1, in one embodiment, an ordnance remediation system includes a separation plant 110 and an inspection plant 120. A feed mixture of dirt and metal, which may be excavated from a munition contaminated area or range, and which may contain unexploded ordnance, is fed into the separation plant 110. The separation plant produces several outputs, which may include a coarse metal output, a fine metal output, and a fine dirt output. The coarse metal output may include a coarse ferrous metal output and a coarse nonferrous metal output, that may be separate from the coarse ferrous metal output. Similarly, the fine metal output may include a fine ferrous metal output and a fine nonferrous metal output, that may be separate from the fine ferrous metal output. As used herein, “metal” parts are parts that contain a significant amount of metal, and that may contain non-metallic components. For example, a piece of unexploded ordnance, which may include, e.g., a ferrous metal shell casing housing an explosive element, is referred to herein as a metal part.

The coarse metal output may contain unexploded ordnance, and it may be the only one of the outputs of the separation plant 110 that potentially includes unexploded ordnance, i.e., the other outputs may contain at most small pieces of explosives and may be relatively nonhazardous. The coarse metal output may be delivered to the inspection plant 120, and may be the feed mixture received by the inspection plant. This feed mixture may include unexploded ordnance, and other, non-hazardous materials. Personnel staffing the inspection plant 120 may observe a stream of metal parts, e.g., using a video camera trained on a conveyor carrying the parts, to classify the metal pieces as nonhazardous metal or unexploded ordnance. The personnel may then take appropriate action to dispose of each piece of unexploded ordnance.

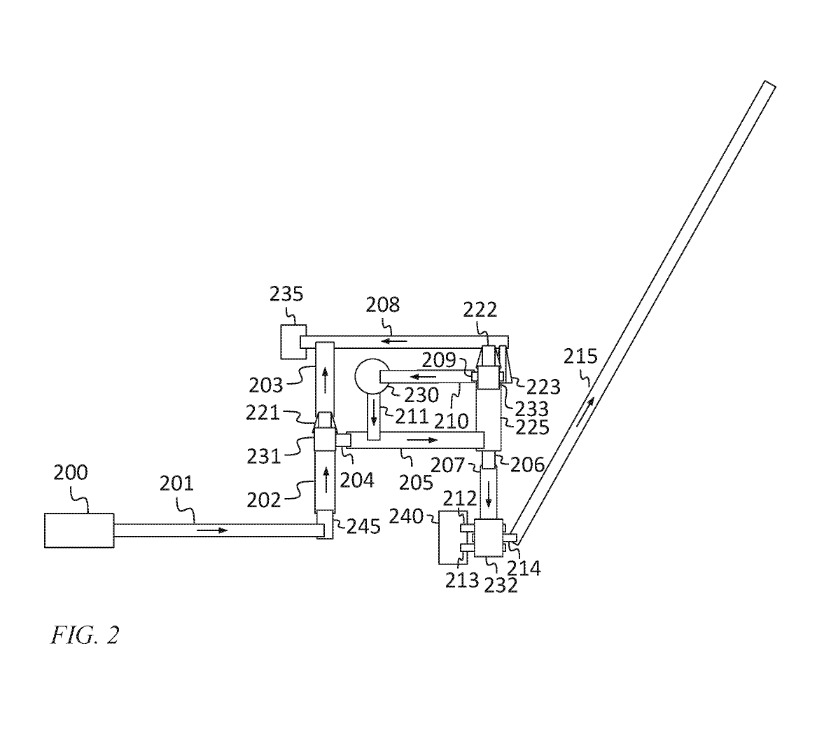

Referring to FIG. 2, in one embodiment, a first part of the separation plant 110 includes several processing stations connected by conveyors. Raw feed material is fed into a jaw crusher 200, the output of which is carried by a first conveyor 201 to a vibrating table 245. In some embodiments, the output of the jaw crusher 200 is fed first to a secondary hopper (not shown) by an additional conveyor (not shown), and is then carried by the first conveyor 201 to the vibrating table 245. In these embodiments the rate at which material is fed to the vibrating table 245 may be controlled by controlling the speed of the first conveyor 201, and the rate at which material is fed into the jaw crusher 200 may be adjusted based on the amount of material in the secondary hopper (e.g., material may be fed into the jaw crusher 200 more quickly when the secondary hopper is nearly empty, and it may be fed into the jaw crusher 200 more slowly when the secondary hopper is nearly full). In some embodiments the secondary hopper may include a flow gate to control the rate at which material leaves the secondary hopper. The raw feed material may be fed into the jaw crusher 200 from a raw material stockpile by an unmanned, or armored manned, piece of earth-moving equipment, depending on the site-specific munition of greatest hazard. An armored control tower may be constructed at the separation plant 110 to allow staff to monitor and control the operation of the equipment in the separation plant 110.

In one embodiment the jaw crusher 200 is fed by excavating raw material from the testing range, and the jaw crusher is on wheels or tracks or otherwise easily moved, so that as the excavation progresses the jaw crusher may be advanced into the munition contaminated site or range, and additional conveyors may be added as the jaw crusher is moved away from the remainder of the separation plant 110 (which may include a secondary hopper for flow rate control). The jaw crusher 200 may include a feed hopper, at the bottom of which may be a set of grizzly bars allowing pieces of material smaller than a threshold size (e.g., 6″) to fall through gaps between the grizzly bars, directly onto the output conveyor (e.g., the first conveyor 201). Video cameras may allow a remote operator to view the contents of the hopper and to intervene when a piece of material appearing to be a piece of unexploded ordinance is identified. This intervention may involve, for example, stopping the operation of the jaw crusher 200, removing the piece of material from the hopper with a remotely-controlled excavator arm (not shown) installed adjacent the jaw crusher 200, setting the piece of material aside, and re-starting the jaw crusher 200.

The vibrating table 245 feeds a second conveyor 202, which carries material to a first magnetic separation station 231. The first magnetic separation station 231 separates ferrous metal pieces from the material it receives and deposits the ferrous metal pieces onto a third conveyor 203 via a first chute 221. The remainder of the material fed to the first magnetic separation station 231 feeds a crushing and separation loop via a fourth conveyor 204, which deposits material onto a fifth conveyor 205. The fifth conveyor 205 feeds a screen plant 225 that may include a ⅝″ screen and that separates fine material (e.g., material that fits through ⅝″ diameter holes in the screen) from coarse material (e.g., material that does not fit through the holes in the screen). In some embodiments the screen is finer or coarser (depending, e.g., on contractually-specified requirements), having, e.g., ½″ diameter holes or 1″ diameter holes. The fine material falls through the screen and is carried, by a sixth conveyor 206 that extends under the screen plant 225 and carries material out from under the screen plant 225 to a seventh conveyor 207. In some embodiments the screen plant 225 includes multiple screens, one above the other, with each screen having larger holes than the one below it, and with the lowest screen allowing the smallest pieces to fall onto the sixth conveyor 206.

Material that does not fall through the screen moves along the top of the screen to a third magnetic separation station 233. At the third magnetic separation station 233, in a first mode of operation, coarse ferrous metal pieces from the top of the screen are sent, via a second chute 222, to an eighth conveyor 208. Other coarse pieces fall from the end of the screen onto a ninth conveyor 209, that may be a part of the screen plant 225, and are deposited onto a tenth conveyor 210. The tenth conveyor 210 feeds a crusher 230, which may be a cone crusher or an impactor (e.g., an impactor with four blow bars). This crusher 230 processes material that has already been processed by the jaw crusher 200, and accordingly may be referred to as the secondary crusher 230. The output of the secondary crusher 230 is then carried, by an eleventh conveyor 211, back onto the fifth conveyor 205, thus forming a loop.

Within the crushing and separation loop, dirt, rock, and metal pieces may circulate counterclockwise as illustrated in FIG. 2. With each pass through the secondary crusher 230, rocks or clods of dirt fed to the secondary crusher 230 may be broken up into smaller pieces. The output of the secondary crusher 230 is carried by the eleventh conveyor 211 and fifth conveyor 205 back to the screen plant 225, where pieces that fit through the screen leave the crushing and separation loop, and pieces that do not fit through the screen return, via the ninth conveyor 209, to the secondary crusher 230. In this manner, each piece of rock delivered to the crushing and separation loop is eventually broken down into pieces sufficiently small to fit through the screen; these pieces then leave the crushing and separation loop via the sixth conveyor 206.

Ferrous metal pieces in the crushing and separation loop leave the loop through the third magnetic separation station 233. Nonferrous metal pieces may not be effectively reduced in size by the secondary crusher 230, and thus may remain too large to fit through the screen of the screen plant 225, even after multiple trips around the crushing and separation loop. Thus, if the feeding of raw material into the separation plant 110 is shut off, the crushing and separation loop may eventually hold only coarse pieces of nonferrous metal, i.e., pieces of nonferrous metal too large to fit through the screen of the screen plant 225. These pieces may be removed from the separation plant 110 by operating the plant temporarily in a second mode, in which the direction of the ninth conveyor 209 is reversed, so that large pieces of nonferrous metal that fall from the end of the screen onto the ninth conveyor 209 are deposited onto the eighth conveyor 208 via a third chute 223.

Both the third conveyor 203 (which carries ferrous metal pieces from the first magnetic separation station 231) and the eighth conveyor 208 (which carries, in the first mode of operation, coarse ferrous metal pieces, and, in the second mode of operation, coarse nonferrous metal pieces) feed a coarse metals bin 235. The coarse metals bin 235 may periodically (e.g., when it is full) be pulled aside and replaced with an empty bin; the full bin may then be transported to the inspection plant 120. In some embodiments, a radial stacker (not shown) may be used to deposit coarse ferrous metal pieces and coarse nonferrous metal pieces into the coarse metals bin 235, or, depending on the position of the radial stacker, other coarse metals bins (not shown). In these embodiments, whenever a coarse metals bin has become full, the radial stacker may be rotated to fill another coarse metals bin. These operations may be performed by a bin-hauling machine (e.g., an unmanned bin-hauling machine or an armored bin-hauling machine). As used herein, a bin-hauling machine is any piece of equipment (e.g., a bulldozer, an excavator, or a roll-off truck) suitable for moving a bin of material.

The seventh conveyor, which carries fine materials from the screen plant 225, feeds a second magnetic separation station 232. At the second magnetic separation station 232, fine ferrous metal pieces are carried, by a twelfth conveyor 212 and a thirteenth conveyor 213, to a fine ferrous metals bin 240. The remainder of the material, which includes fine nonferrous metal pieces and fine rock and dirt, is carried by a fourteenth conveyor 214 to a fifteenth conveyor 215. The fifteenth conveyor 215 may be a radial stacker conveyor.

In operation, the separation plant 110 may, in a first phase of operation, be fed at the jaw crusher 200. The plant may operate, during the first phase, in the first mode of operation, with the ninth conveyor 209 returning large nonferrous pieces to the crushing and separation loop. The plant may operate in this first phase until a significant amount of nonferrous metal has accumulated in the crushing and separation loop. In a second phase of operation, the feeding of new material into the separation plant 110 at the jaw crusher 200 may be temporarily stopped, and the remainder of the separation plant 110 may continue to operate, until the crushing and separation loop contains primarily nonferrous metal pieces. In a third phase of operation, the plant may then be operated in the second mode of operation, with the ninth conveyor 209 operating in reverse, so that material that falls from the end of the screen onto the ninth conveyor 209 is deposited onto the eighth conveyor 208 via the third chute 223, and delivered by the eighth conveyor 208 to the coarse metals bin 235. In one embodiment two different coarse metals bins are used, a first one for coarse ferrous metal pieces and a second one for coarse nonferrous metal pieces; these bins may be interchanged when the separation plant 110 switches between the first and second modes of operation.

The first, second, and third phases may be repeated until a certain quantity of material has accumulated in the coarse metals bin 235. The full coarse metals bin 235 may then be hauled away, e.g., by an unmanned or armored bin-hauling machine, to the inspection plant 120, and an empty coarse metals bin 235 may be put in its place, so that the separation plant 110 may continue to operate.

In each of the first, second, and third phase of operation, fine ferrous metal pieces may be collected in the fine ferrous metals bin 240, and the remaining output material from the first part of the separation plant 110, which may include fine dirt and fine nonferrous metal pieces, may be stacked in one or more stockpiles of ferrous-free dirt by the fifteenth conveyor 215, which may be a radial stacker conveyor.

In one embodiment, the inspection plant 120 is sufficiently far from the separation plant 110 that any explosions at the separation plant 110 (e.g., in the crushers or on the conveyors of the separation plant 110) do not pose a threat to the explosive ordnance disposal experts. As a result, the separation plant 110 need not be stopped during disposal work at the inspection plant 120, and may continue to operate essentially without interruption. This may result in significantly higher throughput than would be achievable, for example, if an inspection station were located directly on, or at the output of, the eighth conveyor 208.

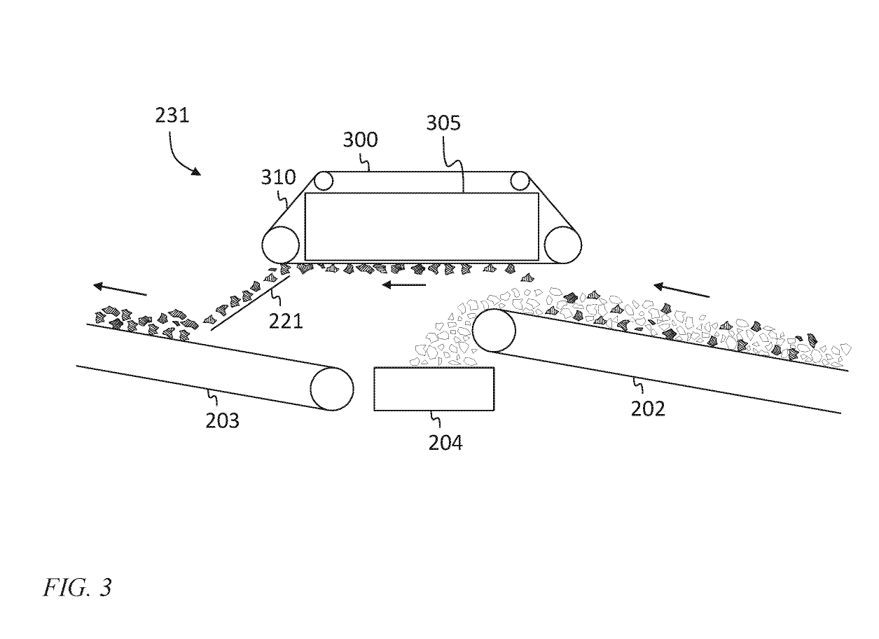

Referring to FIG. 3, in one embodiment the first magnetic separation station 231 includes an overhead magnetic separator 300 including a magnet 305 and an integral conveyor 310 that wraps around the magnet 305. The magnet 305 may be a permanent magnet or an electromagnet. Ferrous metal pieces are picked up from the flow of incoming material by the magnet 305, pulled across the surface of the magnet 305 by the conveyor 310, and dropped onto the first chute 221, to be deposited onto the third conveyor 203. Other nonferrous materials (e.g., dirt, rocks, and nonferrous metal) are deposited onto the fourth conveyor 204. A suitable magnetic separator 300 may be obtained from Eriez, of Erie, Pa. (www.eriez.com).

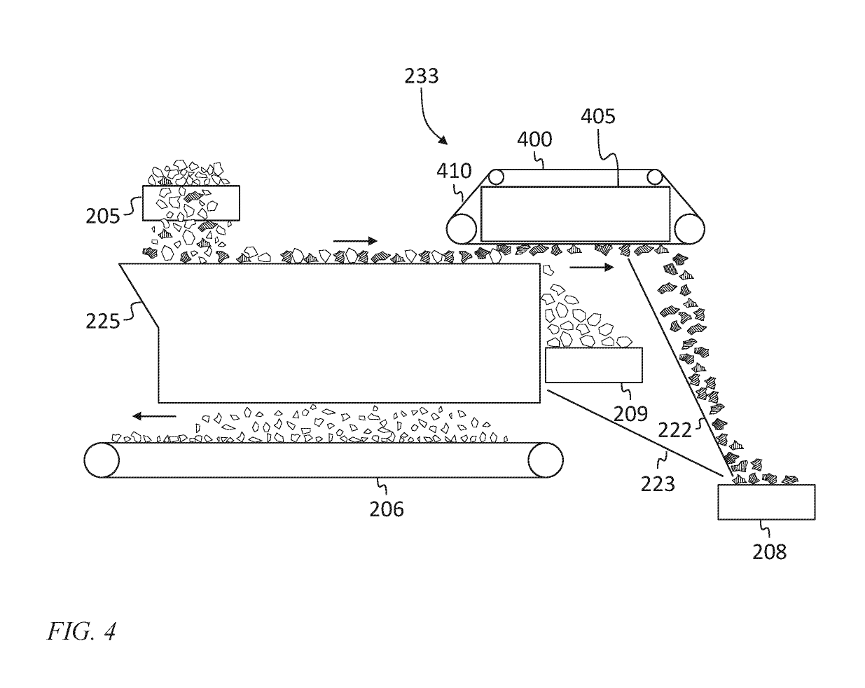

Referring to FIG. 4, in one embodiment the third magnetic separation station 233 may include an overhead magnetic separator 400 including a magnet 405 and an integral conveyor 410 that wraps around the magnet 405. The magnet 405 may be a permanent magnet or an electromagnet. The fifth conveyor 205 feeds the screen plant 225; coarse materials move along the top of the screen, and fine materials fall through the screen onto the sixth conveyor 206. After reaching the end of the screen, the coarse materials are further separated into nonferrous materials (e.g., rocks, and nonferrous metal pieces) that are deposited onto the ninth conveyor 209, and ferrous metal pieces that are deposited onto the eighth conveyor 208 (via the second chute 222). In the first mode of operation (illustrated in FIG. 4) the third chute 223 is unused; in the second mode of operation, the ninth conveyor 209 operates in reverse and deposits nonferrous materials onto the eighth conveyor 208 via the third chute 223.

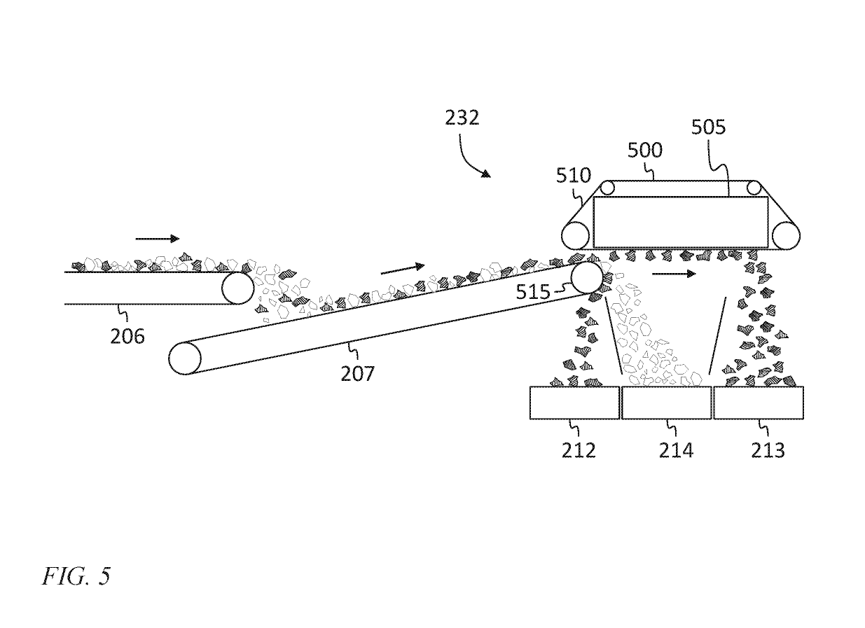

Referring to FIG. 5, in one embodiment the second magnetic separation station 232 is fed a mixture of fine pieces (pieces that fit through the screen of the screen plant 225) by the seventh conveyor 207 (in turn fed by the sixth conveyor 206). Larger ferrous pieces within this stream of material are picked up by an overhead magnetic separator 500 including a magnet 505 and an integral conveyor 510 that wraps around the magnet 505. The overhead magnetic separator 500 is mounted above the end of the seventh conveyor 207, and it deposits the larger ferrous metal pieces onto the thirteenth conveyor 213. The magnet 505 may be a permanent magnet or an electromagnet. The seventh conveyor 207 may include a magnetic head pulley 515 that holds smaller ferrous metal pieces so that they remain on the belt around the pulley and are deposited onto the twelfth conveyor 212. The remaining material, which may include fine nonferrous metal pieces and fine rocks and dirt, is deposited onto the fourteenth conveyor 214. Both the twelfth conveyor 212 and the thirteenth conveyor 213 feed the ferrous metal pieces they receive to the fine ferrous metals bin 240 (FIG. 2). The fourteenth conveyor 214 feeds the fifteenth conveyor 215, which forms stockpiles of ferrous-free dirt. Some nonferrous metal may remain in the ferrous-free dirt and become part of the stockpiles.

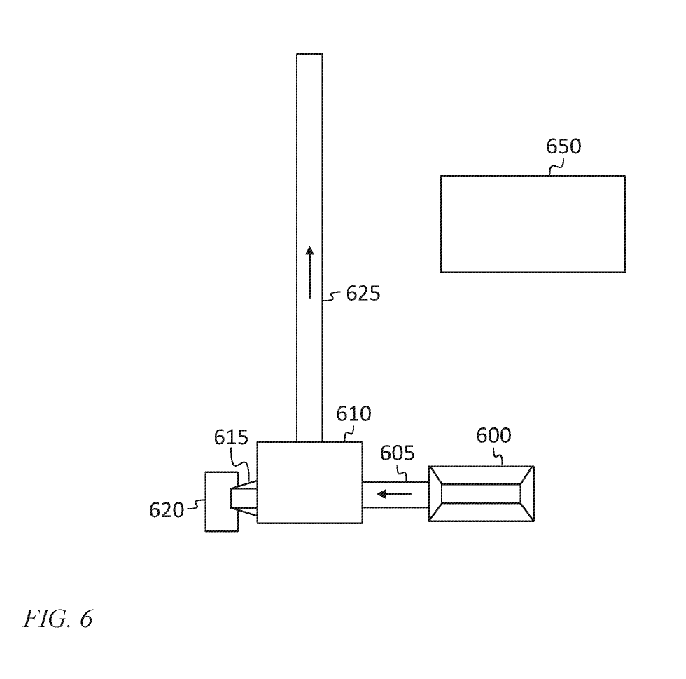

Referring to FIG. 6, in one embodiment, in a second part of the separation plant, dirt from one of the one or more stockpiles of ferrous-free dirt fed by the fifteenth conveyor 215 may be further processed to remove nonferrous metal pieces. The ferrous-free dirt may be moved, e.g., by an unmanned, or manned armored, piece of earth-moving equipment, from one of the one or more stockpiles of ferrous-free dirt and placed in a hopper 600. Dirt may fall from the bottom of the hopper onto a conveyor 605 and carried to a nonferrous metal separation station 610. In the nonferrous metal separation station 610, nonferrous metal pieces (which are sufficiently small to have fit through the screen of the screen plant 225) may be separated and dropped, through a chute 615, into a fine nonferrous metal bin 620. The remainder of the dirt, from which the nonferrous metal pieces have been removed, may then be carried by a conveyor 625 to one or more stockpiles of metal-free dirt. The conveyor 625 may be a radial stacker conveyor. Those of skill in the art will understand that the metal-free dirt need not be entirely free of metal, but that this term refers to dirt that has undergone one or more process to remove metal (e.g., processes to remove ferrous metal and other processes to remove nonferrous metal), and that e.g., small pieces of metal may remain in the metal-free dirt.

In one embodiment the nonferrous metal separation station 610 includes an eddy current separator, available from Eriez, of Erie, Pa. (www.eriez.com). Such a separator may include moving magnets that produce, in the stream of material being processed, moving magnetic fields, that, in turn generate eddy currents in any conductive pieces of material in the stream. Magnetic fields produced by the eddy currents then interact with the magnetic fields from the magnets to generate forces on the conductive pieces of material, diverting the conductive pieces of material (e.g., pieces of nonferrous metal) from the path of the remainder of the stream of material, and, e.g., onto the chute 615. In one embodiment several nonferrous metal separation stations are operated in parallel, e.g., fed by different output chutes from the intake hopper 600, to provide greater processing capacity.

The stockpile or stockpiles of ferrous-free dirt formed by the fifteenth conveyor 215 may act to decouple the processing rates of the first second parts of the of the separation plant 110, so that, for example, the first part of the separation plant 110 may continue to operate even if the second part of the separation plant 110 is temporarily shut down, or vice versa, or so that the first part of the separation plant 110 may continue to operate even if the processing capacity of the second part of the separation plant 110 is less than that of the first part of the separation plant 110. In some embodiments, additional conveyors may be installed between the fourteenth conveyor 214 and the fifteenth conveyor 215, to extend the stockpile or stockpiles from the remainder of the separation plant 110. In some embodiments, the fifteenth conveyor 215 may, instead of forming one or more stockpiles, feed the nonferrous metal separation station 610 directly.

The coarse metal output stream or streams may be treated as sufficiently hazardous to merit further processing in the inspection plant 120. The remaining output streams from the separation plant may be composed of pieces that are sufficiently small to fit through the screen and that may pose little hazard. Nonetheless the material in these streams may not be entirely safe; for example, a munition that is fractured in the separation plant (or before being brought to the separation plant) may produce fragments of explosive material. To further reduce the hazard the material in these remaining output streams may pose, the material from each of these streams may be heat treated in a heat treatment facility 650, e.g., it may be briefly heated in a suitable furnace, causing any explosive fragments to decompose.

In one embodiment, a simplified separation plant has only one crusher, one screen plant, and one magnetic separation station, arranged in a loop similar to the loop of FIG. 2 including the secondary crusher 230, the screen plant 225, and the first magnetic separation station 231. Material to be separated is delivered to the screen, the output of which feeds the magnetic separation station. Large ferrous pieces are sent to the inspection plant, other large pieces are fed back to the crusher, and small pieces are piled up as minimally-hazardous dirt, or heat-treated and piled up as nonhazardous dirt.

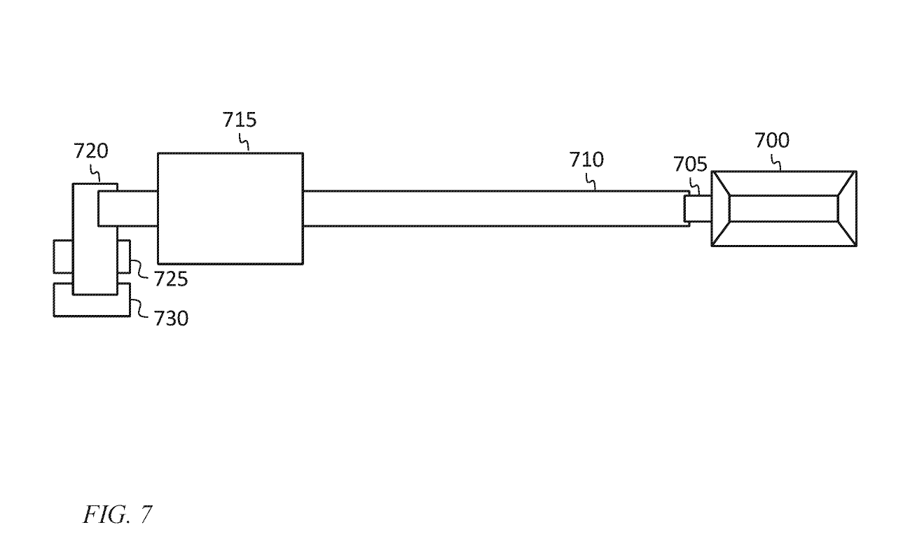

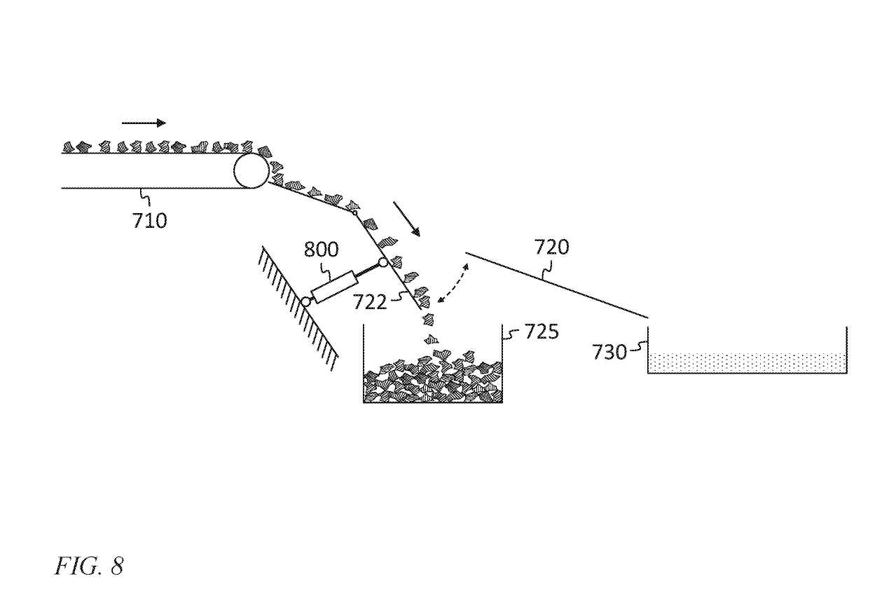

Referring to FIG. 7, in one embodiment coarse metal pieces from the separation plant 110 are deposited into a feed hopper 700 at the inspection plant 120. From the feed hopper 700 the coarse metal pieces are carried, by a feed conveyor 705, to an inspection conveyor 710, which carries the coarse metal pieces through an inspection area 715. In the inspection area, each coarse metal piece is inspected, e.g., by personnel in a bunker, or by personnel using a video link, to determine whether it is potentially a piece of unexploded ordnance. The inspection conveyor deposits the pieces it carries into chute 720 which may be a chute with a trap door (e.g., a pant-leg chute). When the pieces being deposited in the chute 720 are not unexploded ordnance, the trap door 722 (FIG. 8) is kept open, and the pieces drop through the trap door into a storage bin 725. When a piece of unexploded ordnance is identified, the trap door is closed before the piece falls off of the end of the inspection conveyor 710, so that the piece is dropped into a sand pan 730.

Referring to FIG. 8, in one embodiment the trap door is closed by an actuator 800 such as a pneumatic cylinder or a hydraulic ram, that may be operated remotely by personnel monitoring the material on the inspection conveyor 710.

In embodiments of the present invention various pieces of equipment such as crushers, magnetic separation stations, conveyors, and screen plants, may be arranged in various configurations with material from one piece of equipment delivered to another. The region or location at which a piece of equipment receives material (such as the top opening of a crusher, or the region in which material first comes within the region of influence of a magnetic separator) is referred to herein as the “input” of the piece of equipment. Similarly, the location or region from which a piece of equipment discharges material (e.g., the bottom opening of a crusher) is referred to herein as the “output” of the piece of equipment. When the system is configured so that material produced at the output of a first piece of equipment is delivered to the input of a second piece of equipment, the output of the first piece of equipment is referred to herein as being “connected” to the input of the second piece of equipment. The output of a first piece of equipment may be referred to herein as being “directly connected” to the input of a second piece of equipment only if there are no intervening pieces of equipment. For example, if a crusher is installed above a screen plant so that material drops from the crusher directly onto the screen plant, then the output of the crusher is connected to the input of the screen plant and the output of the crusher is also directly connected to the input of the screen plant. If the crusher is adjacent to the screen plant and a conveyor carries material from the output of the crusher to the input of the screen plant, then the output of the crusher is connected to the input of the screen plant, but the output of the crusher is not directly connected to the input of the screen plant.

As used herein, an “unmanned” piece of equipment is a piece of equipment that may operate without a human operator being in direct contact with (e.g., sitting in the cab of) the piece of equipment. An unmanned piece of equipment may be operated remotely by an operator standing at a distance and watching the piece of equipment, or by an operator in a control room with remote controls for controlling the piece of equipment and a video feed for monitoring its operations. An unmanned piece of equipment may operate autonomously, e.g., it may execute pre-programmed tasks without real-time participation of a human operator.

Although exemplary embodiments of an ordnance remediation system have been specifically described and illustrated herein, many modifications and variations will be apparent to those skilled in the art. Accordingly, it is to be understood that an ordnance remediation system constructed according to principles of this invention may be embodied other than as specifically described herein. The invention is also defined in the following claims, and equivalents thereof.

What is claimed is:

1. A system for eliminating unexploded ordnance from a mixture, the system comprising:
a separation plant, comprising:
a first crusher having an input and an output, the first crusher being configured to receive a stream of pieces of material at the input and to produce, at the output, a stream of pieces of material of reduced size,
a first magnetic separation station having an input, a first output, and a second output, and being configured to receive a stream of material at the input and to produce respective output streams of material at the first output and at the second output, by directing ferrous metal pieces to the second output; and
a screen plant having an input, a first output and a second output, and being configured to receive a stream of material at the input, and to produce respective output streams of material at the first output and at the second output, by directing pieces larger than a threshold size to the first output and directing pieces smaller than a threshold size to the second output; and
an inspection plant having an input for receiving, from the separation plant, pieces larger than the threshold size, the inspection plant comprising an inspection station for identifying unexploded ordnance among the received pieces,
each of the first crusher, the first magnetic separation station, and the screen plant having an input or an output connected to an input or an output of another of the first crusher, the first magnetic separation station, and the screen plant,
the inspection plant being sufficiently distant from the separation plant to prevent unexploded ordnance at the separation plant from posing a personnel hazard at the inspection plant.

2. The system of claim 1, wherein each of the first crusher, the first magnetic separation station, and the screen plant has an input or an output connected to an input or an output of another of the first crusher, the first magnetic separation station, and the screen plant by a conveyor.

3. The system of claim 1, wherein the distance between the separation plant and the inspection plant is at least 1,000 feet.

4. The system of claim 1, wherein in a first mode of operation:
the first output of the screen plant is connected to the input of the first magnetic separation station;
the first output of the first magnetic separation station is connected to the input of the first crusher;
the second output of the first magnetic separation station is connected to a storage bin for large metal pieces; and
the output of the first crusher is connected to the input of the screen plant.

5. The system of claim 4, wherein, in a second mode of operation:
the first output of the screen plant is connected to the input of the first magnetic separation station;
the first output of the first magnetic separation station is connected to the storage bin for large metal pieces; and
the output of the first crusher is connected to the input of the screen plant.

6. The system of claim 1, further comprising a second magnetic separation station having an input, a first output, and a second output, and being configured to receive a stream of material at the input and to produce respective output streams of material at the first output and at the second output, by directing ferrous metal pieces to the second output,
wherein the first output of the second magnetic separation station is connected to the screen plant and the second output of the second magnetic separation station is connected to a storage bin for large metal pieces.

7. The system of claim 6, further comprising a second crusher having an input and an output, the second crusher being configured to receive a stream of pieces of material at the input and to produce, at the output, a stream of pieces of material of reduced size,
wherein the output of the second crusher is connected to the input of the second magnetic separation station.

8. The system of claim 7, wherein the second crusher is a jaw crusher.

9. The system of claim 7, further comprising an unmanned piece of earth-moving equipment for feeding the second crusher.

10. The system of claim 1, further comprising a third magnetic separation station having an input, a first output, a second output, and a third output, and being configured to receive a stream of material at the input and to produce respective output streams of material at the first output, at the second output, and at the third output, by directing ferrous metal pieces to the second output or to the third output,
wherein the second output of the screen plant is connected to the input of the third magnetic separation station.

11. The system of claim 10, wherein the third magnetic separation station comprises a magnetic separator configured to direct ferrous metal pieces to the third output of the third magnetic separation station.

12. The system of claim 11, wherein the third magnetic separation station further comprises a conveyor with a magnetic head pulley configured to direct ferrous metal pieces to the second output of the third magnetic separation station.

13. The system of claim 1, further comprising:
a stacker conveyor having an input and an output; and
a first stockpile at the output of the stacker conveyor,
wherein the input of the stacker conveyor is connected to the second output of the screen plant.

14. The system of claim 1, further comprising an eddy current separator having an input, a first output, and a second output, and being configured to process an input stream of material and to produce a first output stream of material and a second output stream of material, by directing electrically conductive pieces into the second output stream,
wherein the input of the eddy current separator is connected to the second output of the screen plant.

15. The system of claim 1, wherein the first crusher is an impactor.

16. The system of claim 1, wherein each connection between:
the first crusher,
the first magnetic separation station, and
the screen plant
includes a conveyor.

17. The system of claim 1, further comprising an unmanned bin-hauling machine for moving a bin containing pieces of material larger than the threshold size to the inspection plant.

18. The system of claim 1, wherein the inspection plant comprises a conveyor configured to display metal pieces for inspection, the conveyor feeding a chute with a trap door, the chute being configured to deposit metal pieces in a storage bin when the trap door is open, and to deposit metal pieces into a sand pan when the trap door is closed.

19. A method for eliminating unexploded ordnance from a stream of material, the method comprising:
at a first location:
crushing pieces in an input stream to form an output stream;
separating pieces in an input stream into two output streams, according to magnetic characteristics of the pieces; and
separating pieces in an input stream into two output streams, according to the size of the pieces relative to a threshold size;
transporting pieces larger than the threshold size to a second location sufficiently remote from the first location that an explosion at the first location does not pose a personnel hazard at the second location; and
identifying, at the second location, potentially explosive pieces,
wherein each of the processes of crushing, separating according to magnetic characteristics, and separating according to size comprises receiving material from or providing material to another of the processes of crushing, separating according to magnetic characteristics, and separating according to size.
